(19) United States
(12) Patent Application Publication
(10) Pub. No.: US 2015/0044976 A1
(43) Pub. Date: Feb. 12, 2015

(54) WIRELESS COMMUNICATION MODULE AND MANUFACTURING METHOD THEREOF

(71) Applicant: SAMSUNG ELECTRO-MECHANICS CO., LTD., Suwon-Si (KR)

(72) Inventor: Hyung Goo BAEK, Suwon-Si (KR)

(21) Appl. No.: 14/456,956

(22) Filed: Aug. 11, 2014

(30) Foreign Application Priority Data
Aug. 12, 2013 (KR) 10-2013-0095413

(51) Int. Cl. H04B 1/40; H04B 1/38

(52) U.S. Cl. CPC H04B 1/40; H04B 1/3827
USPC 455/73; 29/601

(57) ABSTRACT

Disclosed herein are a wireless communication module and a manufacturing method thereof. The wireless communication module includes: a high frequency module transmitting and receiving a high frequency signal for wireless communication; a main IC mounted in the high frequency module, configuring a wireless communication related circuit and processing a signal; and a passive electronic component mounted in the high frequency module and performing an auxiliary function in connection with the signal processing. As set forth above, with the wireless communication module according to the exemplary embodiments of the present invention, it is possible to remarkably reduce the overall height of the module and save the manufacturing cost thereof due to the process simplification, by configuring the module by reversing the concept of the modularized (packaged) portion and the components mounted in the module (package).

This application claims the foreign priority benefit under 35 U.S.C. Section 119 of Korean Patent Application Serial No. 10-2013-0095413 entitled “Wireless Communication Module And Manufacturing Method Thereof” filed on Aug. 12, 2013, which is hereby incorporated by reference in its entirety into this application.

### BACKGROUND OF THE INVENTION

1. Technical Field

The present invention relates to a wireless communication module and a manufacturing method thereof, and more particularly, to a wireless communication module capable of solving problems, such as limitation of slimness, complexity of a production process, and occurrence of a frequent defect in a module product using an embedded type PCB, and a manufacturing method thereof.

2. Description of the Related Art

In the case of a modularized product according to the related art, an embedded type PCB structure has been used to reduce a physical size, but a manufacturing process is complicated and a product defect frequently occurs, and therefore there is a need to solve the problems.

That is, a WiFi module having a multi-layer structure according to the related art is configured to include a PCB as a base and a mold structure molding an upper surface of the PCB. The PCB as the base is configured to have a bonding structure of a first PCB and a second PCB and semiconductor chips (LNA, PA, and the like) and passive electronic components (resistor, capacitor, and the like) are mounted in a quadrangular hole formed in the second PCB.

According to the related art, the multi-layer type WiFi module having the foregoing structure adopts the embedded type PCB structure, such that the slimness of the module may be restricted and it may be difficult to design the multi-layer type module of 1.35 mm or less.

### RELATED ART

### Patent Document

(Patent Document 1) Korean Patent Laid-Open Publication No. 10-2009-0055974

(Patent Document 2) Japanese Patent Laid-Open Publication No. 2007-129304

### SUMMARY OF THE INVENTION

An object of the present invention is to provide a wireless communication module capable of solving problems, such as limitation of module slimness, complexity of a production process, and frequent occurrence of a product defect, in a module product using an embedded type PCB, by configuring a module by changing a concept of a modularized (packaged) portion and components mounted in a module (package) in a structure of the module using an embedded type PCB according to the related art, and a manufacturing method thereof.

According to an exemplary embodiment of the present invention, there is provided a wireless communication module, including: a high frequency module transmitting and receiving a high frequency signal for wireless communication and manufactured using a system in package (SIP) technique which mounts the high frequency module on a substrate in a “bare-die” state; a main IC mounted in the high frequency module, for configuring a wireless communication related circuit and processing a signal; and a passive electronic component mounted in the high frequency module and performing an auxiliary function in connection with the signal processing.

The wireless communication module may further include a molding material molding the whole of one surface of the high frequency module, so as to have the main IC and the passive electronic component embedded therein.

The molding material may be an epoxy mold compound (EMC).

The high frequency module may include a PCB, a front end module (FEM) mounted on the PCB, a passive electronic component, and a molding material embedding these components.

The FEM may include at least one of a low noise amplifier (LNA), a power amplifier (PA), and a filter.

According to another exemplary embodiment of the present invention, there is provided a manufacturing method of a wireless communication module, including: a) manufacturing a high frequency module which transmits and receives a high frequency signal for wireless communication and is manufactured using a system in package (SIP) technique which mounts the high frequency module on a substrate in a “bare-die” state; b) mounting the main IC for configuring a wireless communication related circuit and processing a signal on one surface of the high frequency module; and c) mounting a passive electronic component performing an auxiliary function in connection with the signal processing on one surface of the high frequency module to approach the main IC.

The manufacturing method of a wireless communication module may further include: d) molding the whole of one surface of the high frequency module, in which the main IC and the passive electronic component are mounted, with a molding material so as to have the main IC and the passive electronic component embedded therein.

The molding material may be an EMC.

a) the manufacturing of the high frequency module may include: a-1) manufacturing a PCB having a predetermined thickness or preparing a previously manufactured PCB having a predetermined thickness; a-2) mounting an FEM and a passive electronic component on an upper surface of the PCB; and a-3) manufacturing an overall integrated single mold package by molding the whole of the upper surface of the PCB, in which the FEM and the passive electronic component are mounted, with the molding material.

The FEM may include at least one of a low noise amplifier (LNA), a power amplifier (PA), and a filter.

### BRIEF DESCRIPTION OF THE DRAWINGS

FIG. 1 is a diagram illustrating a structure of a wireless communication module according to an exemplary embodiment of the present invention.

FIG. 2 is a diagram illustrating a structure of a high frequency module of the wireless communication module illustrated in FIG. 1.

FIG. 3 is a flow chart illustrating an execution process of a manufacturing method of a wireless communication module according to an exemplary embodiment of the present invention.

FIGS. 4A to 4C are diagrams sequentially illustrating a manufacturing process of the wireless communication module according to the exemplary embodiment of the present invention.

FIG. 5 is a flow chart illustrating the execution process of the manufacturing method of the high frequency module adopted in the wireless communication module according to the exemplary embodiment of the present invention.

FIGS. 6A to 6C are diagrams sequentially illustrating a manufacturing process of the high frequency module adopted in the wireless communication module according to the exemplary embodiment of the present invention.

### DESCRIPTION OF THE PREFERRED EMBODIMENTS

Terms and words used in the present specification and claims are not to be construed as a general or dictionary meaning, but are to be construed to meaning and concepts meeting the technical ideas of the present invention based on a principle that the inventors can appropriately define the concepts of terms in order to describe their own inventions in the best mode.

Throughout the present specification, unless explicitly described to the contrary, “comprising” any components will be understood to imply the inclusion of other elements rather than the exclusion of any other elements. A term “part”, “module”, “device”, or the like, described in the specification means a unit of processing at least one function or operation and may be implemented by hardware or software or a combination of hardware and software.

Hereinafter, exemplary embodiments of the present invention will be described with reference to the accompanying drawings.

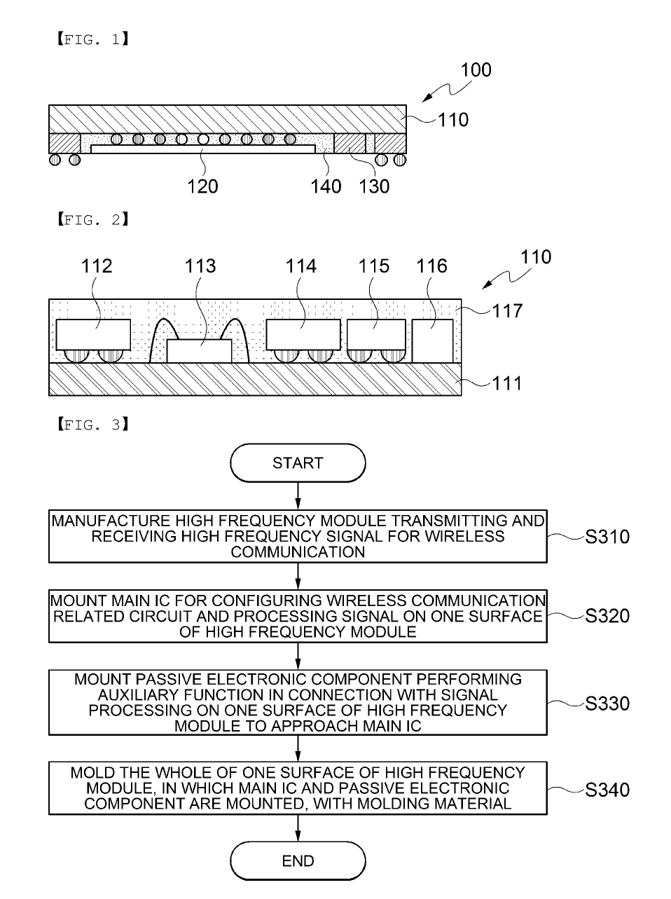

FIG. 1 is a diagram illustrating a structure of a wireless communication module according to an exemplary embodiment of the present invention.

Referring to FIG. 1, a wireless communication module 100 according to the exemplary embodiment of the present invention may be configured to include a high frequency module 110, a main IC 120, and a passive electronic component 130.

The high frequency module 110 transmits and receives a high frequency signal for wireless communication. As described above, the high frequency module 110 is manufactured using a system in package (SIP) technique which mounts the high frequency module 110 on a substrate in a “bare-die” state and as illustrated in FIG. 2, may be configured to include a PCB 111, a front end module (FEM) mounted on the PCB 111, a passive electronic component 116, and a molding material 117 having these components embedded therein.

In this case, as the PCB 111, a PCB having a multi-layer (for example, 4-layer) structure may be used. In this case, a PCB of a single layer may also be used.

Further, the FEM may include at least one of low noise amplifiers (LNAs) 112 and 114, a power amplifier (PA) 113, and a filter 115 (for example, low pass filter (LPF) or band pass filter (BPF), and the like).

Further, as the passive electronic component 116, a resistor or a capacitor may be used.

Further, as the molding material 117 having the components as described above embedded therein to configure a single mold package as a whole along with the PCB 111, any synthetic resin material having electrically good insulation may be used, preferably, an epoxy mold compound (EMC) is used.

The main IC 120 is mounted in the high frequency module 110 having the above configuration, configures a wireless communication related circuit and processes a transmitted and received signal. As such, the mounting of the main IC 120 may be configured by forming a ball bump on a lower surface of the PCB 111 of the high frequency module 110 and then bonding the main IC 120 to the ball bump.

The passive electronic component 130 is mounted in the high frequency module 110 and performs an auxiliary function in connection with the signal processing by the main IC 120. As the passive electronic component 130, a resistor or a capacitor may be used.

Preferably, the wireless communication module 100 according to the exemplary embodiment of the present invention may further include a molding material 140. The molding material 140 molds the whole of one surface (lower surface in the drawing) of the high frequency module 110 so as to have the main IC 120 and the passive electronic component 130 embedded therein. In this case, as the molding material 140, the EMC may be used.

Hereinafter, a manufacturing method of a wireless communication module according to the exemplary embodiment of the present invention having the foregoing configuration will be described.

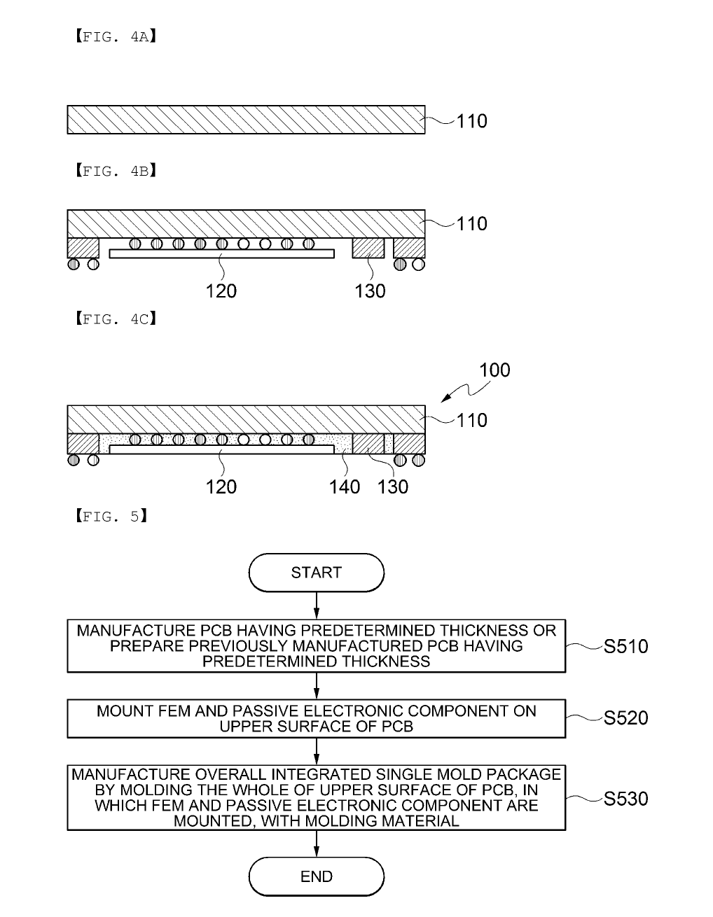

FIG. 3 is a flow chart illustrating an execution process of a manufacturing method of a wireless communication module according to an exemplary embodiment of the present invention and FIGS. 4A to 4C are diagrams sequentially illustrating a manufacturing process of the wireless communication module according to the exemplary embodiment of the present invention.

Referring to FIGS. 3 and 4A to 4C, according to the manufacturing method of the wireless communication module according to the exemplary embodiment of the present invention, the high frequency module 110 which transmits and receives a high frequency signal for wireless communication is manufactured (S310). The manufacturing of the high frequency module 110 will be separately described below.

When the manufacturing of the high frequency module 110 is completed, the main IC 120 for configuring the wireless communication related circuit and processing the transmitted and received signal is mounted on the one surface (the lower surface of the high frequency module 110 in the present drawing) (S320). That is, the main IC 120 is mounted in the high frequency module 110 by forming the ball bump on the lower surface of the PCB 111 (see FIG. 3) of the high frequency module 110 and then bonding the main IC 120 to the ball bump. Actually, the high frequency module 110 is aligned so that the PCB 111 portion of the high frequency module 110 become a top surface by rotating 180° the high frequency module 110 illustrated in FIG. 3 to change a position of the top and bottom thereof, the surface of the PCB 111 is formed with the ball bump, and then the main IC 120 is bonded to the ball bump.

By doing so, when the mounting of the main IC 120 is completed, the passive electronic component 130 which performs an auxiliary function in connection with the signal processing approaches the main IC 120 to be mounted on the one surface of the high frequency module 110 (S330). The exemplary embodiment of the present invention describes that after the main IC 120 is first mounted in the high frequency module 110, the passive electronic component 130 is mounted, but the main IC 120 and the passive electronic component 130 are not necessarily mounted in the high frequency module 110 in an order described above. In some cases, after the passive electronic component 130 is mounted, the main IC 120 may be mounted and the main IC 120 and the passive electronic component 130 may be simultaneously mounted.

As described above, after the main IC 120 and the passive electronic component 130 are mounted in the high frequency module 110, preferably, the manufacturing method of the wireless communication module may further include molding the whole of the one surface of the high frequency module 110, in which the main IC 120 and the passive electronic component 130 are mounted, with the molding material so as to have the main IC 120 and the passive electronic component 130 embedded therein (S340). In this case, as the molding material 140, any synthetic resin material having electrically good insulation may be used, preferably, the epoxy mold compound (EMC) may be used.

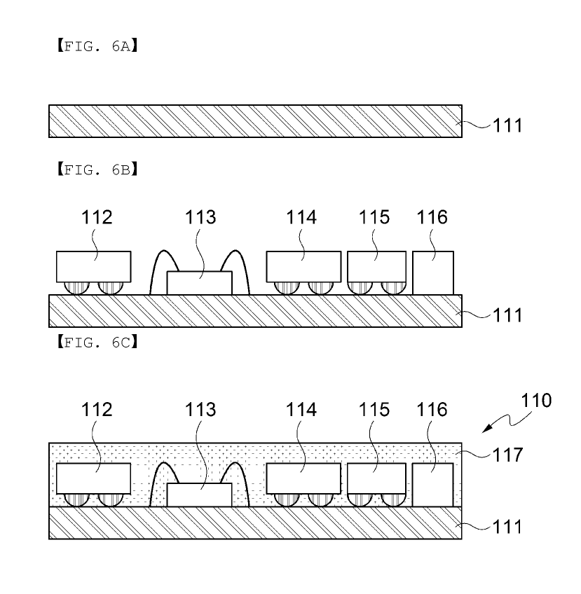

Meanwhile, FIGS. 5 and 6A to 6C illustrate a manufacturing method of a high frequency module adopted in the wireless communication module according to the exemplary embodiment of the present invention, in which FIG. 5 is a flow chart illustrating an execution process of the manufacturing method and FIGS. 6A to 6C are diagrams sequentially illustrating the manufacturing process.

Herein, the high frequency module 110 may be manufactured using a system in package (SIP) technique which mounts the high frequency module 110 on the substrate in the “bare-die” state.

Referring to FIGS. 5 and 6A to 6C, in order to manufacture the high frequency module 110, the PCB 111 having a predetermined thickness (for example, 0.2 mm) is manufactured or the previously manufactured PCB 111 having a predetermined thickness is prepared (S510).

When the PCB 111 is prepared, the front end module (FEM) and the passive electronic component 116 are mounted on the upper surface of the PCB 111 (S520). In this case, the FEM may include at least one of the low noise amplifiers (LNAs) 112 and 114, the power amplifier (PA) 113, and the filter 115. Further, as the passive electronic component 116, the resistor or the capacitor may be used.

By doing so, when the FEM and the passive electronic component 116 are mounted on the PCB 111, the whole of the upper surface of the PCB 111, on which the front end module (FEM) and the passive electronic component 116 are mounted, is molded with the molding material 117, thereby manufacturing the overall integrated single mold package, that is, the high frequency module 110 (S530). In this case, as the molding material 117, the EMC may be used. In this case, a molding thickness by the molding material 117 does not preferably exceed 0.4 mm.

As described above, according to the wireless communication module and the manufacturing method thereof according to the exemplary embodiment of the present invention, in configuring the module by changing (reversing) the concept of the modularized (packaged) portion and the components mounted in the module (package), the high frequency module 110 may be manufactured using a system in package (SIP) technique which mounts the high frequency module 110 on the substrate in the “bare-die” state, thereby remarkably reducing the overall height of the module and saving the manufacturing cost thereof due to the process simplification.

As set forth above, according to the exemplary embodiments of the present invention, it is possible to remarkably reduce the overall height of the module and save the manufacturing cost thereof due to the process simplification, by configuring the module by changing (reversing) the concept of the modularized (packaged) portion and the components mounted in the module (package).

Although the exemplary embodiments of the present invention have been disclosed for illustrative purposes, the present invention is not limited thereto, but those skilled in the art will appreciate that various modifications, additions and substitutions are possible, without departing from the scope and spirit of the invention as disclosed in the accompanying claims. Therefore, the protection scope of the present invention must be analyzed by the appended claims and it should be analyzed that all spirits within a scope equivalent thereto are included in the appended claims of the present invention.

What is claimed is:

1. A wireless communication module, comprising:
a high frequency module transmitting and receiving a high frequency signal for wireless communication and manufactured using a system in package (SIP) technique which mounts the high frequency module on a substrate in a “bare-die” state;
a main IC mounted in the high frequency module, for configuring a wireless communication related circuit and processing a signal; and
a passive electronic component mounted in the high frequency module and performing an auxiliary function in connection with the signal processing.

2. The wireless communication module according to claim 1, further includes a molding material molding the whole of one surface of the high frequency module, so as to have the main IC and the passive electronic component embedded therein.

3. The wireless communication module according to claim 2, wherein the molding material is an epoxy mold compound (EMC).

4. The wireless communication module according to claim 1, wherein the high frequency module includes a PCB, a front end module (FEM) mounted on the PCB, a passive electronic component, and a molding material embedding these components.

5. The wireless communication module according to claim 4, wherein the FEM includes at least one of a low noise amplifier (LNA), a power amplifier (PA), and a filter.

6. The wireless communication module according to claim 4, wherein the passive electronic component is a resistor or a capacitor.

7. A manufacturing method of a wireless communication module, comprising:
a) manufacturing a high frequency module which transmits and receives a high frequency signal for wireless communication and is manufactured using a system in package (SIP) technique which mounts the high frequency module on a substrate in a “bare-die” state;
b) mounting the main IC for configuring a wireless communication related circuit and processing a signal on one surface of the high frequency module; and
c) mounting a passive electronic component performing an auxiliary function in connection with the signal processing on one surface of the high frequency module to approach the main IC.

8. The manufacturing method according to claim 7, further comprising:
d) molding the whole of one surface of the high frequency module, in which the main IC and the passive electronic component are mounted, with a molding material so as to have the main IC and the passive electronic component embedded therein.

9. The manufacturing method according to claim 8, wherein the molding material is an EMC.

10. The manufacturing method according to claim 7, wherein a) the manufacturing of the high frequency module includes:
a-1) manufacturing a PCB having a predetermined thickness or preparing a previously manufactured PCB having a predetermined thickness;
a-2) mounting an FEM and a passive electronic component on an upper surface of the PCB; and
a-3) manufacturing an overall integrated single mold package by molding the whole of the upper surface of the PCB, in which the FEM and the passive electronic component are mounted, with the molding material.

11. The manufacturing method according to claim 10, wherein the FEM includes at least one of a low noise amplifier (LNA), a power amplifier (PA), and a filter.

12. The manufacturing method according to claim 10, wherein the passive electronic component is a resistor or a capacitor.
